(19) United States
(12) Patent Application Publication
(10) Pub. No.: US 2007/0139555 A1
(43) Pub. Date: Jun. 21, 2007

(54) TV signal processor

(75) Inventor: Yu-Chiang Shih, Taipei Hsien (TW)

Correspondence Address: BIRCH STEWART KOLASCH & BIRCH, PO BOX 747, FALLS CHURCH, VA, 22040-0747, US

(73) Assignee: ANIMATION TECHNOLOGIES INC.

(21) Appl. No.: 11/638,509

(22) Filed: Dec. 14, 2006

(30) Foreign Application Priority Data
Dec. 16, 2005 (TW) 094222061

(51) Int. Cl. H04N 3/27; H04N 5/04

(52) U.S. Cl. 348/554; 348/500

(57) ABSTRACT

A TV signal processor is disclosed to include a signal receiver for receiving an external TV signal, a signal processor that demodulates the TV signal received from the signal receiver, a decoder that decodes the demodulated TV signal into a digital multimedia file format or digital multimedia stream format, a first transmission interface electrically connected to the decoder and electrically connectable to an external apparatus for receiving and transmitting signals, a bridge, and a second transmission interface electrically connected to the first transmission interface through the bridge for transmitting the decoded TV signal from the decoder or output data/command from the external apparatus to a host for output.

### BACKGROUND OF THE INVENTION

1. Field of the Invention

The present invention relates to TV signal processors and more particularly, to such a TV signal processor, which combines an input/output interface card and a TV card into a integrated device, thereby providing an added value, improving the convenience of use and saving much the manufacturing cost.

2. Description of the Related Art

The connection between a computer and a peripheral apparatus is achieved by means of an interface circuit built in the computer. This interface circuit can be a PCI interface, IDE interface, USB interface, PCMCIA interface or PCI-EXPRESS interface. A computer may be equipped with many different interface cards for the connection of different peripheral apparatus. However, one interface card occupies one interface slot. This arrangement greatly increases the equipment and installation cost of the computer. In order to eliminate this drawback, I/O cards are developed to have different input/output ports and slots be installed in one interface card to increase the number of input/output interfaces.

Further, since the creation of TV, plasma and LCD TVs have been intensively used to substitute for early CRT type monochrome TVs and CRT type color TVs. The modern advanced TVs provide high definition, high contrast ratio, and colorful output. TV channels have been increased from few channels to more than one hundred channels. Following the step of time, TV signal transmission has also been digitalized.

The display of a TV signal, either an analog TV signal or digital TV signal, is done by means of a particular play mode. A TV monitor is connected to a video transceiver through a signal line for playing audio and video signals. A computer monitor must be connected to a computer for display of computer internal data. Following the stream of time, the nature of a computer monitor has been greatly changed. A computer can be connected to the Internet to receive remote signals. By means of a webcam, a computer can receive real-time video signal. In consequence, modern computer monitors can be used for different purposes. Nowadays, a computer monitor can be used with a computer for playing TV programs. However, a computer and a TV belong to different categories and use different A/V signal receiving, transmitting and playing programs. For watching TV programs on a computer, a set-top box or TV card must be used to convert TV audio & video signals into computer readable signals.

Therefore, it is desirable to provide a TV processor that combine an I/O card and a TV card to provided an added value, to effectively reduce the manufacturing cost, and to have the limited number of connection ports of a computer to be fully utilized.

### SUMMARY OF THE INVENTION

The present invention has been accomplished under the circumstances in view. It is therefore the main object of the present invention to provide a TV signal processor, which combines an input/output interface card and a TV card into a integrated device, thereby providing an added value, improving the convenience of use and saving much the manufacturing cost.

To achieve this and other objects of the present invention, the TV signal processor comprises a signal receiver for receiving an external TV signal, a signal processor that demodulates the TV signal received from the signal receiver, a decoder that decodes the demodulated TV signal into a digital multimedia file format or digital multimedia stream format, a first transmission interface electrically connected to the decoder and electrically connectable to an external apparatus for receiving and transmitting signals, a bridge, and a second transmission interface electrically connected to the first transmission interface through the bridge for transmitting the decoded TV signal from the decoder or output data/command from the external apparatus to a host for output.

### BRIEF DESCRIPTION OF THE DRAWINGS

FIG. 1 is a system block diagram of a TV signal processor in accordance with a first embodiment of the present invention.

FIG. 2 is a system block diagram of a TV signal processor in accordance with a second embodiment of the present invention.

FIG. 3 is a system block diagram of a TV signal processor in accordance with a third embodiment of the present invention.

FIG. 4 is a system block diagram of a TV signal processor in accordance with a fourth embodiment of the present invention.

### DETAILED DESCRIPTION OF THE PREFERRED EMBODIMENT

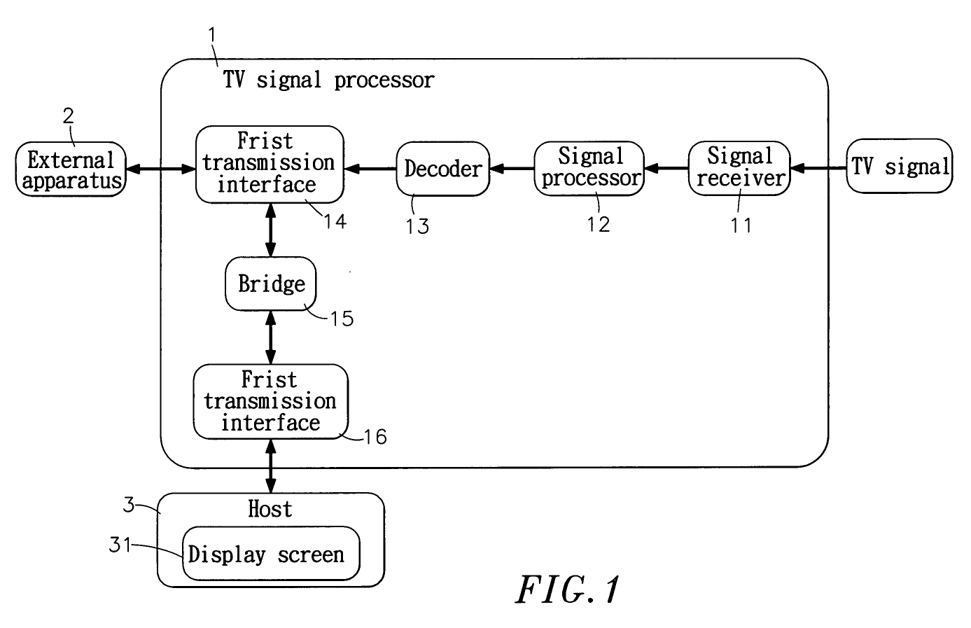

Referring to FIG. 1, a TV signal processor 1 in accordance with a first embodiment of the present invention is shown comprised of a signal receiver 11, a signal processor 12, a decoder 13, a first transmission interface 14, a bridge 15 and a second transmission interface 16.

The signal receiver 11 is adapted to receive external TV signals. The external TV signal can be a digital TV signal or an analog TV signal.

The signal processor 12 is electrically connected to the signal receiver 11, and adapted to receive and demodulate the TV signal that is received by the signal receiver 11.

The decoder 13 is electrically connected to the signal processor 12, and adapted to receive and decode the TV signal that is demodulated by the signal processor 12.

The first transmission interface 14 is electrically connected to the decoder 13, and electrically connectable to an external apparatus 2 for receiving and transmitting signals.

The bridge 15 is electrically connected to the first transmission interface 14 for interface conversion control.

The second transmission interface 16 is electrically connected to the bridge 15, and adapted to transmit the TV signal decoded by the decoder 13 to a host, referenced by 3.

The aforesaid external TV signal can be DVB-T, DVB-C, DVB-H, DVB-S, ATSC, ISDB-T, DMB-T digital or analog TV signal. However, the invention is not limited to the processing of the aforesaid various different TV signals. Further, the signal receiver 11 can be a radio frequency signal receiver or coaxial cable connector. By means of the application of the present invention, the TV signal processor can be made to process any of a variety of TV signals.

Referring to FIG. 1 again, after connection of the second transmission interface 16 of the TV signal processor 1 to the host 3, a user can connect the first transmission interface 14 to any of a variety of external apparatus 2 such as printer, card reader, digital camera, video camera, PDA, cell phone, mouse, keyboard, video device, mobile hard disk drive, memory stick, recorder pen, MP3 player and etc., for enabling the connected external apparatus 2 to transmit data or command to the host 3 through the second transmission interface 14 via the bridge 15.

When the user wishes to watch TV programs, the signal receiver 11 is used to receive the external TV signal. Because the TV signal is delivered by means of carrier wave, the signal receiver 11 transmits the carrier wave carried TV signal to the signal processor 12 for enabling the carrier wave to be removed from the TV signal. After removal of the carrier wave, the signal processor 12 transmits the TV signal to the decoder 13, which decodes the TV signal into a digital multimedia file format or digital multimedia stream format. The decoder 13 transmits the decoded TV signal in proper order through the first transmission interface 14, the bridge 15 and the second transmission interface 16 to the host 3 for output through a display screen 31 of the host 3. Thus, the user can watch analog TV programs as well as digital TV programs by means of the display screen 31 of the host 3.

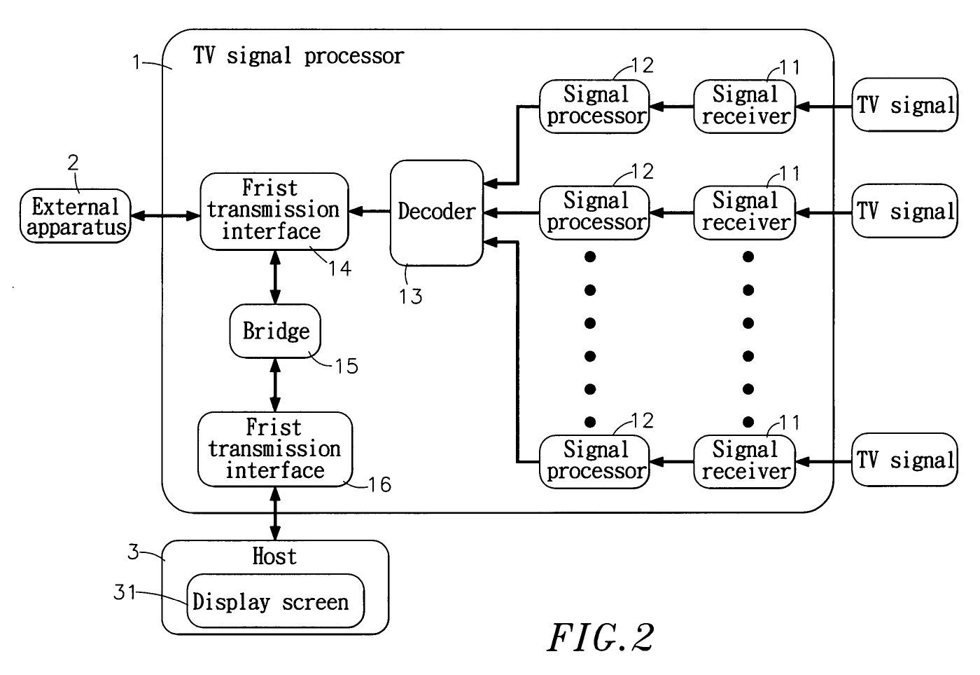

FIG. 2 is a system block diagram of a TV signal processor in accordance with a second embodiment of the present invention. This embodiment is substantially similar to the aforesaid first embodiment with the exception of the use of multiple signal receivers and multiple signal processors, i.e., multiple signal receivers 11 are arranged in parallel and adapted to receive different TV signals from different TV signal sources, and multiple signal processors 12 are respectively connected between the signal receivers 11 and the decoder 13 for transmitting different TV signals to the decoder 13. This embodiment enables the user to watch different TV programs at the same time.

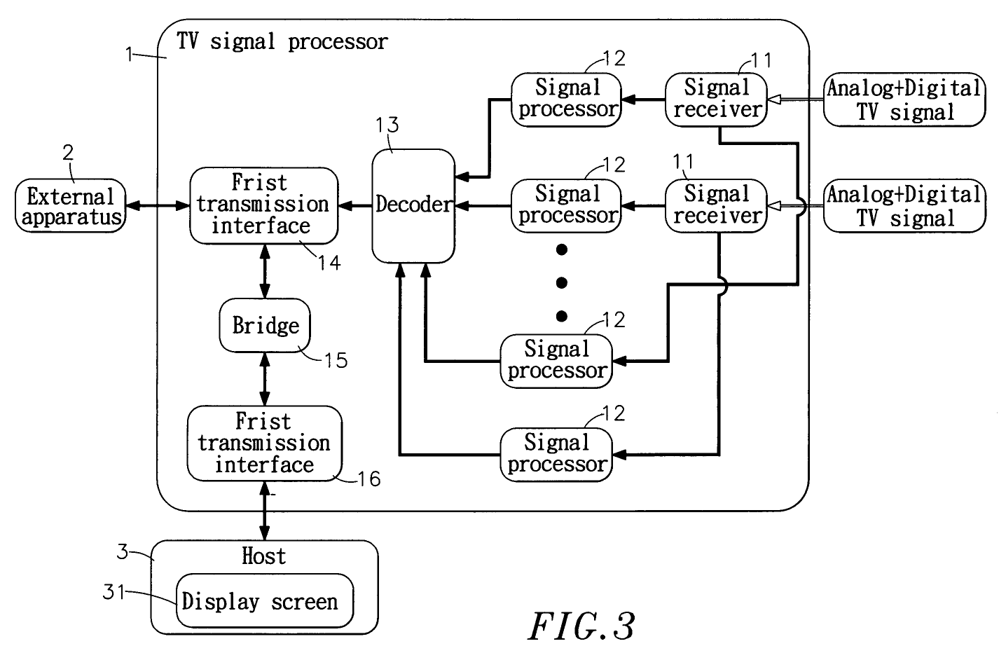

FIG. 3 is a system block diagram of a TV signal processor in accordance with a third embodiment of the present invention. This embodiment uses multiple signal receivers 11 and multiple signal processors 12. The signal receivers 11 are adapted to receive analog TV signals and digital TV signals, and to transmit analog TV signals and digital TV signals to different signal processors 12 for processing (demodulation), enabling the user to watch analog TV programs and digital TV programs through the display screen 31 of the host 3. Further, the host 3 has software means for enabling the user to switch between the analog TV program output mode and the digital TV program output mode.

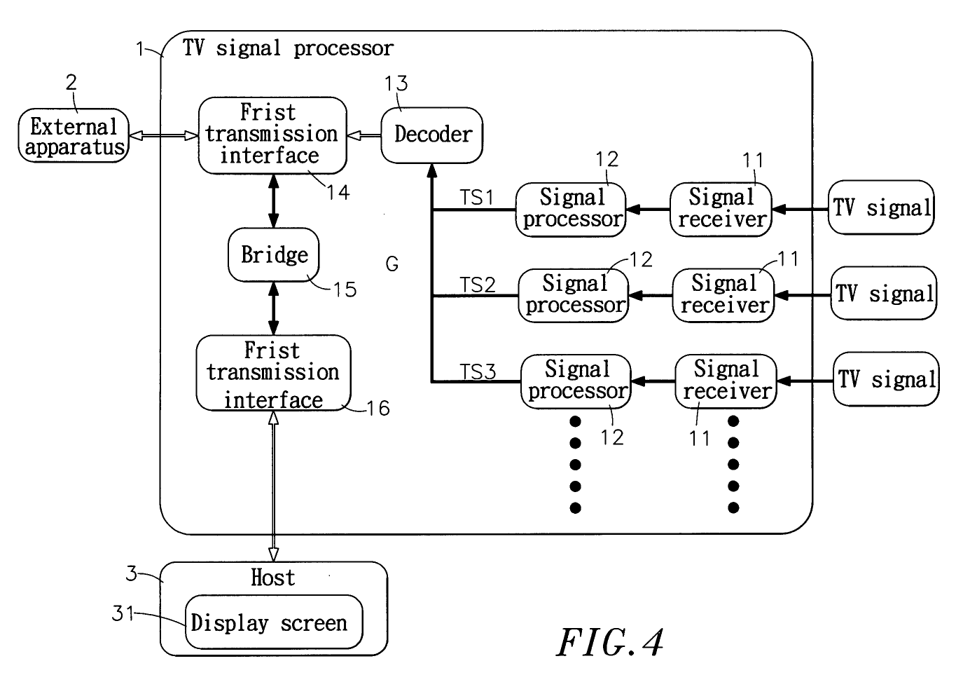

FIG. 4 is a system block diagram of a TV signal processor in accordance with a fourth embodiment of the present invention. According to this embodiment, the TV signal processor 1 uses multiple signal receivers 11 to receive external TV signals from different TV signal sources, and multiple signal processors 12 to demodulate the received same type or different types of TV signals, for enabling the demodulated TV signals (TS1, TS2, TS3 . . . ) to be sent to the decoder 13 by means of a parallel combined method (one single signal line) for decoding. This embodiment also allows the user to switch between the analog TV program output mode and the digital TV program output mode.

Further, the aforesaid first transmission interface 14 can be a PCI, USB, PCMCIA or IEEEE1394. The aforesaid second transmission interface 16 can be a MINI-CARD, PCI-EXPRESS, EXPRESS-CARD or Add-In card. However, these interface devices are simple examples of the present invention, not a limitation. The signal processors 12 can be a single-chip type or multi-chip type digital signal processors, analog signal processors or other types of signal processors capable of demodulate carrier wave carried TV signals. The bridge 15 can be a PCI-to-PCI EXPRESS bridge or any suitable bridge means capable of separating two or more network segments within one logical network.

As stated above, the invention provides a TV signal processor, which has the following benefits:
1. The invention uses the first transmission interface 14 to connect an external apparatus 2 and the bridge 15 for interface conversion control, so that the connected external apparatus 2 is allowed to transmit data or command to the host 3 through the second transmission interface 16. The invention also uses the signal receiver(s) 11 to receive external TV signals, for enabling the received TV signals to be processed through the signal processor(s) 12 and the decoder 13 and then transmitted through the second transmission interface 16 to the host 3 for output. By means of the display screen 31 of the host 3, the user can watch analog TV programs as well as digital TV programs. The invention combines an input/output interface card and a TV card into an integrated TV signal processor, providing an added value, improving the convenience of use and saving much the manufacturing cost.
2. The invention uses multiple signal receivers 11 to receive different TV signals from different TV signal sources, multiple signal processors 12 to demodulate received TV signals, and one decoder 13 to decode TV signals into digital multimedia file format or digital multimedia stream format TV signals for transmission to the host 3 through the first transmission interface 14, the bridge 15 and the second transmission interface 16 for output through the display screen 31. Therefore, the user can watch many different TV programs at a time.

A prototype of TV signal processor has been constructed with the features of FIGS. 1-4. The TV signal processor functions smoothly to provide all of the features discussed earlier.

Although particular embodiments of the invention has been described in detail for purposes of illustration, various modifications and enhancements may be made without departing from the spirit and scope of the invention. Accordingly, the invention is not to be limited except as by the appended claims.

What the invention claimed is:

1. A TV signal processor comprising:
at least one signal receiver, said at least one signal receiver being connected to a respective external TV signal source for receiving a respective TV signal;
at least one signal processor respectively electrically connected to said at least one signal receiver and adapted to receive and demodulate the TV signal that is received by the associating signal receiver;
a decoder electrically connected to said at least one signal processor and adapted to receive and decode each TV signal that is demodulated by said at least one signal processor;
a first transmission interface electrically connected to said decoder and electrically connectable to an external apparatus for receiving and transmitting signals;
a bridge electrically connected to said first transmission interface for interface conversion control;
a second transmission interface electrically connected to said bridge and adapted to transmit each TV signal decoded by said decoder to a host for output.

2. The TV signal processor as claimed in claim 1, wherein said at least one signal receiver each is adapted to receive one of the TV signals of DVB-T, DVB-C, DVB-H, DVB-S, ATSC, ISDB-T, DMB-T digital and analog TV signals.

3. The TV signal processor as claimed in claim 1, wherein said at least one signal receiver includes at least one of a radio frequency signal receiver and a coaxial cable connector.

4. The TV signal processor as claimed in claim 1, wherein said at least one signal processor each is selected from the group of digital signal processor and analog signal processor.

5. The TV signal processor as claimed in claim 1, wherein said at least one signal processor each is selected from the group of single-chip signal processor and multi-chip signal processor.

6. The TV signal processor as claimed in claim 1, wherein said first transmission interface is selected from the group of PCI, USB, PCMCIA, and IEEEE1394.

7. The TV signal processor as claimed in claim 1, wherein said second transmission interface is selected from the group of MINI-CARD, PCI-EXPRESS, EXPRESS-CARD, and Add-In Card.

8. The TV signal processor as claimed in claim 1, wherein said bridge is a PCI-to-PCI Express bridge.
